(19) United States
(12) Patent Application Publication
(10) Pub. No.: US 2008/0296458 A1
(43) Pub. Date: Dec. 4, 2008

(54) Retention spring for recessed lighting fixture

(75) Inventors: Jeffrey Lee Gibson, Florence, AL (US); Doug Miles, Fayetteville, GA (US)

Correspondence Address: KING & SPALDING LLP, 1180 PEACHTREE STREET, ATLANTA, GA, 30309-3521, US

(73) Assignee: Cooper Technologies Company, Houston, TX (US)

(21) Appl. No.: 11/984,117

(22) Filed: Nov. 13, 2007

Related U.S. Application Data
(60) Provisional application No. 60/865,513, filed on Nov. 13, 2006.

(51) Int. Cl. F21S 8/02

(52) U.S. Cl. 248/318

(57) ABSTRACT

Preventing air leakage in a recessed lighting fixture. A plaster frame extends between hanger bars fastened to ceiling supports or joists. The plaster frame includes an aperture sized to receive a can. The can includes a pair of slots. A pair of retention springs are coupled to the plaster frame, on opposite sides of the aperture. Each retention spring is associated with one of the slots of the can. Each retention spring includes a base member and an elongated engaging member extending from an end of the base member. The elongated engaging member has a surface that has a contour corresponding to an outer profile of the can, proximate the slot. For example, a radius of curvature of the surface can correspond to a radius of curvature of the can. Thus, the retention springs engage the can in a substantially air-tight manner.

### RELATED PATENT APPLICATION

This patent application claims priority under 35 U.S.C. § 119 to U.S. Provisional Patent Application No. 60/865,513, entitled “Halo Lighting Fixture Can Spring Retention,” filed Nov. 13, 2006, the complete disclosure of which is hereby fully incorporated herein by reference.

### TECHNICAL FIELD

The invention relates generally to recessed lighting fixtures and more particularly to a retention spring for preventing air leakage in a recessed lighting fixture having a height-adjustable can.

### BACKGROUND

A recessed lighting fixture is a light fixture that is installed in a hollow opening in a ceiling. A typical recessed lighting fixture includes hanger bars fastened to spaced-apart ceiling supports or joists. A plaster frame extends between the hanger bars and includes an aperture configured to receive a lamp housing or “can.” A bottom edge of an installed can should be flush with a bottom edge of the ceiling. Thus, the bottom of the installed lighting fixture is mounted flush with the visible surface of the ceiling, and the body of the lighting fixture projects in the space above the ceiling.

Ceiling panels are constructed in varying thicknesses. For example, a ceiling panel can have a thickness from about ¼″ to about 1½″. A recent approach to accommodating these different thicknesses is to provide a recessed lighting fixture with a height-adjustable can. The can includes a pair of vertical slots through which horizontally disposed fastening devices, such as screws, can engage corresponding tabs extending from the plaster frame of the fixture. An operator can translate the can up and down relative to a horizontal plane of the ceiling until the bottom edge of the can is flush with the bottom edge of the ceiling. Once the bottom edge of the can is flush with the bottom edge of the ceiling, the operator can use a micro-sized screwdriver to fasten the screws into the tabs of the plaster frame, thereby securing the position of the can relative to the ceiling. A substantially direct relationship exists between the thickness of the ceiling and the vertical distance between the fastened screws and the bottom edge of the can.

To accommodate varying ceiling thicknesses, each slot must be at least about 1¼″ long. Each screw only extends through a small portion of that length. The remaining portions are unsealed, allowing conditioned air beneath the ceiling to leak into unconditioned spaces, such as ceiling or attic cavities.

Air leakage is undesirable because it increases fuel bills, causes discomfort, and leads to moisture problems. Therefore, some states, including Washington, are requiring all recessed lighting fixtures to meet strict air tightness requirements. In particular, Washington's State Energy Code requires recessed lighting fixtures to restrict measured air leakage to less than 2 cubic feet per minute at 75 Pascals pressure difference, tested according to a test method set forth in ASTM International Standard E-283.

One conventional approach to meeting these requirements is to provide one or more gaskets between the can and each tab. The gaskets help to prevent air from leaking through the disengaged portions of the slots. However, the additional costs of acquiring, manufacturing, and installing the gaskets make this approach undesirable. In addition, the gaskets do not provide a complete solution to the air tightness constraints for height-adjustable cans having slots up to 1¼″ long. Therefore, manufacturers traditionally have not been able to provide air-tight light fixtures with height-adjustable cans capable of accommodating all ceiling thicknesses between about ¼″ and 1½″.

Therefore, a need exists in the art for preventing air leakage in a recessed lighting fixture having a height-adjustable can. In particular, a need exists in the art for cost-efficient systems and methods for preventing air leakage in such a recessed lighting fixture. A further need exists in the art for cost-efficient systems and methods for preventing air leakage in a height-adjustable can capable of accommodating all ceiling thicknesses between about ¼″ and 1½″.

### SUMMARY

The invention provides systems and methods for preventing air leakage in a recessed lighting fixture. Specifically, the invention provides cost-efficient systems and methods for preventing air leakage in a recessed lighting fixture having a height-adjustable can. For example, the can may be configured to accommodate ceiling thicknesses between about ¼″ and 1½″.

The light fixture includes hanger bars fastened to ceiling supports or joists. A plaster frame extends between the hanger bars. The plaster frame includes an aperture sized to receive a can.

The can includes a substantially dome shaped member configured to receive a lamp. A pair of vertical slots extend through opposite sides of the can. As described below, the vertical slots accommodate vertical translation of the can within the aperture of the plaster frame. The lengths of the vertical slots can vary depending on the different ceiling thicknesses to be accommodated by the light fixture. For example, each vertical slot can have a length up to about 1¼″ to accommodate ceiling thicknesses between about ¼″ and 1½″.

A pair of retention springs are coupled to the plaster frame, on opposite sides of the aperture. Each retention spring is associated with one of the vertical slots of the can. Each retention spring includes a base member and an elongated engaging member extending from an end of the base member. The elongated engaging member has a surface disposed opposite the base member that has a contour corresponding to an outer profile of the can, proximate the vertical slot associated with the retention spring. For example, a radius of curvature of the surface can correspond to a radius of curvature of the can. Thus, the retention springs can engage the can in a substantially air-tight manner.

In certain aspects of the invention, each retention spring may include a receiving member extending from a top end of the engaging member. For example, an axis of the receiving member may form an acute angle with an axis of the engaging member. Each of the receiving member and the engaging member can include an aperture configured to receive a fastener for securing the can to the retention spring. For example, the apertures can be configured to receive the fastener at a non-zero angle, such as a 45 degree angle, relative to an axis of the base member. Such an angle can allow an operator to use a standard-sized tool to install and adjust the can within the aperture.

In certain additional aspects of the invention, each retention spring may include a support member extending from a bottom end of the receiving member. For example, an axis of the support member can form an acute angle, such as a 45 degree angle, with the axis of the engaging member. The support member may be configured to limit bending by the retention spring once the can is fastened to the retention spring.

To install the can within the light fixture, an operator can translate the can up and down within the aperture of the plaster frame until a bottom edge of the can is flush with a bottom edge of the ceiling. Once the bottom edge of the can is flush with the bottom edge of the ceiling, the operator can align the slots in the can with their corresponding retention springs. Specifically, the operator can align the slots with the apertures of the engaging members of the retention springs. The operator can secure the can to the retention springs by translating a fastener through the apertures of the engaging member and receiving member of each retention spring using a standard-sized screwdriver or other fastening tool.

To adjust the height of the can after the can is installed within the light fixture, the operator can loosen the fasteners using the standard-sized screwdriver or other fastening tool, translate the can up or down within the aperture of the plaster frame until the can reaches a desired position, and secure the can in the desired position by re-tightening the fasteners within the apertures of the retention springs. The form-fitting relationship between the can and the retention springs allows the engaging member to engage the can (and the vertical slots thereof) in a substantially air-tight manner throughout translation of the can within the aperture and at any selected height of the can.

These and other aspects, objects, features, and advantages of the invention will become apparent to a person of ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 is a perspective, exploded view of components of a recessed lighting fixture, according to certain exemplary embodiments.

FIG. 2 is a perspective side view of a plaster frame of a recessed lighting fixture, according to certain exemplary embodiments.

FIG. 3 is an exploded side view of a can, gaskets, and retention springs of a recessed lighting fixture, according to certain exemplary embodiments.

FIG. 4 is an isometric view of a retention spring of a recessed lighting fixture, according to certain exemplary embodiments.

FIG. 5 is a perspective, side view of the retention spring of FIG. 4, according to an exemplary embodiment.

FIG. 6 is a perspective, front view of the retention spring of FIG. 4, according to an exemplary embodiment.

FIG. 7 is a perspective, bottom view of the retention spring of FIG. 4, according to an exemplary embodiment.

FIG. 8 is a perspective, front view of a retention spring of a recessed lighting fixture, according to certain alternative exemplary embodiments.

FIG. 9 is a perspective, side view of a retention spring of a recessed lighting fixture, according to certain additional alternative exemplary embodiments.

FIG. 10 is a perspective, side view of a retention spring of a recessed lighting fixture, according to certain additional alternative exemplary embodiments.

FIG. 11 is a perspective, side view of a retention spring of a recessed lighting fixture, according to certain additional alternative exemplary embodiments.

FIG. 12 is a perspective, side view of a retention spring of a recessed lighting fixture, according to certain additional alternative exemplary embodiments.

FIG. 13 is a perspective, side view of a retention spring of a recessed lighting fixture, according to certain additional alternative exemplary embodiments.

### DETAILED DESCRIPTION OF EXEMPLARY EMBODIMENTS

The invention is directed to cost-efficient systems and methods for preventing air leakage in a recessed lighting fixture. In particular, the invention is directed to a retention spring for preventing air leakage in a recessed lighting fixture having a height-adjustable can.

Turning now to the drawings, in which like numerals indicate like elements throughout the figures, exemplary embodiments of the invention are described in detail.

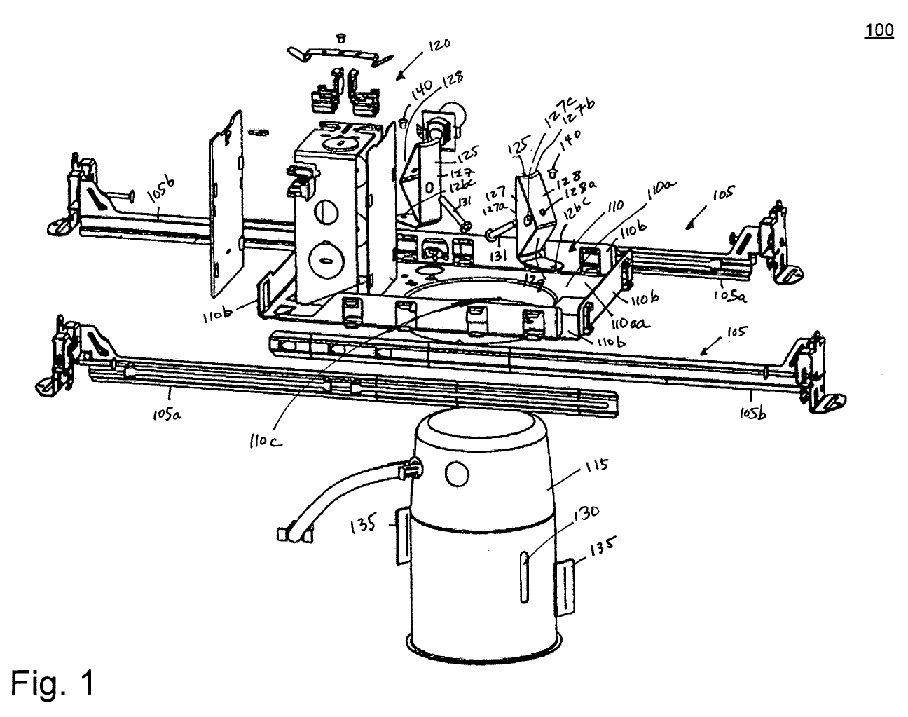

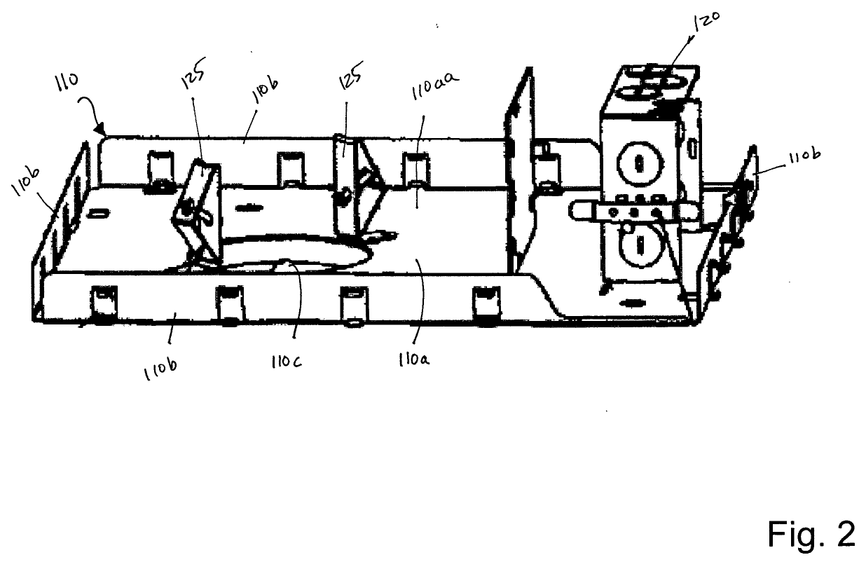

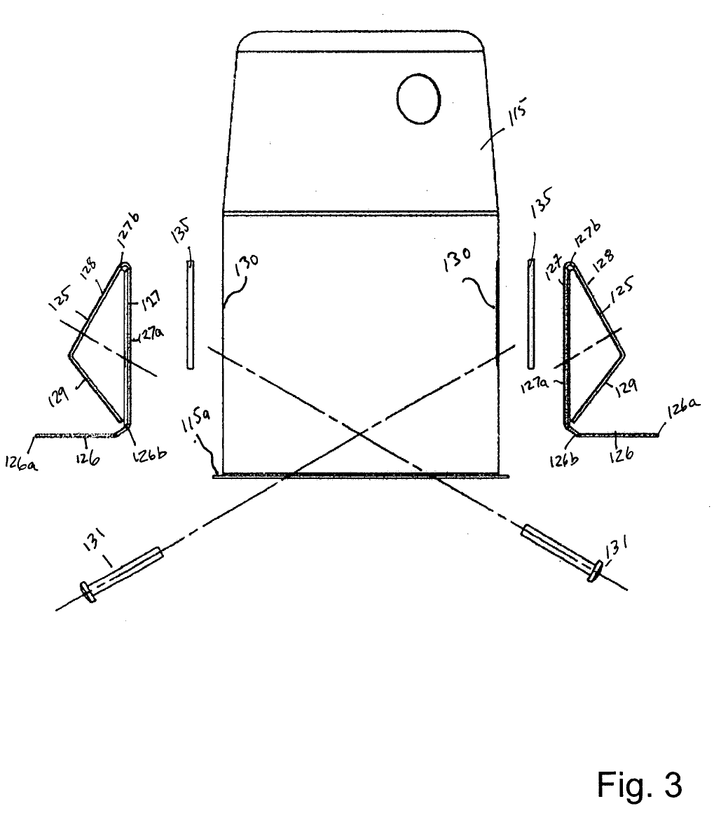

FIG. 1 is a perspective, exploded view of hanger bars 105, a plaster frame 110, a can 115, a junction box 120, retention springs 125, and gaskets 135 of a recessed lighting fixture 100, according to certain exemplary embodiments. FIG. 2 is a perspective, side view of the assembled plaster frame 110, junction box 120, and retention springs 125 of FIG. 1, according to certain exemplary embodiments. FIG. 3 is an exploded side view of the can 115, gaskets 135, and retention springs 125 of FIG. 1, according to certain exemplary embodiments.

With reference to FIGS. 1-3, the hanger bars 105 are configured to be mounted between spaced supports or joists (not shown) within a ceiling (not shown). For example, ends of the hanger bars 105 can be fastened to vertical faces of the supports or joists by nailing or other means. In certain exemplary embodiments, the hanger bars 105 can include integral fasteners for attaching the hanger bars 105 to the supports or joists, substantially as described in co-pending U.S. patent application Ser. No. 10/090,654, entitled “Hanger Bar for Recessed Luminaires with Integral Nail,” the complete disclosure of which is hereby fully incorporated herein by reference.

The distance between supports or joists can vary to a considerable degree. Therefore, in certain exemplary embodiments, the hanger bars 105 can have adjustable lengths. Each hanger bar 105 includes two inter-fitting members 105a and 105b that are configured to slide in a telescoping manner to provide a desired length of the hanger bar 105. A person of ordinary skill in the art having the benefit of the present disclosure will recognize that many other suitable means exist for providing adjustable length hanger bars 105. For example, in certain alternative exemplary embodiments, one or more of the hanger bars described in U.S. Pat. No. 6,105,918, entitled “Single Piece Adjustable Hanger Bar for Lighting Fixtures,” the complete disclosure of which is hereby fully incorporated herein, may be utilized in the lighting fixture 100 of FIG. 1.

The plaster frame 110 extends between the hanger bars 105 and includes a generally rectangular, flat plate 110a with upturned edges 110b. For example, the flat plate 110a can rest on a top surface of the ceiling. The junction box 120 is mounted to a top surface 110aa of the flat plate 110a. The junction box 120 is a box with insulated wiring terminals and knock-outs for connecting external wiring (not shown) to a lamp (not shown) disposed within the can 115 of the light fixture 100.

The plaster frame 110 includes a generally circular aperture 110c sized for receiving the can 115. The can 115 includes a substantially dome shaped member configured to receive the lamp and, in certain exemplary embodiments, a reflector and/or trim package (not shown). The aperture 110c provides an illumination pathway for the lamp. A person of ordinary skill in the art having the benefit of the present disclosure will recognize that, in certain alternative exemplary embodiments, the aperture 110c can have another, non-circular shape that corresponds to an outer profile of the can 115.

A pair of vertical slots 130 extend through opposite sides of the can 115. The retention springs 125 are coupled to the plaster frame 110, on opposite sides of the aperture 110c. Each retention spring 125 is associated with one of the vertical slots 130 of the can 115. When the can 115 is installed within the aperture 110c of the plaster frame 110, each retention spring 125 is disposed proximate to its corresponding vertical slot 130. The lengths of the vertical slots 130 can vary depending on the different ceiling thicknesses to be accommodated by the light fixture 100. For example, each vertical slot 130 can have a length up to about 1¼″ to accommodate ceiling thicknesses between about ¼″ and 1½″.

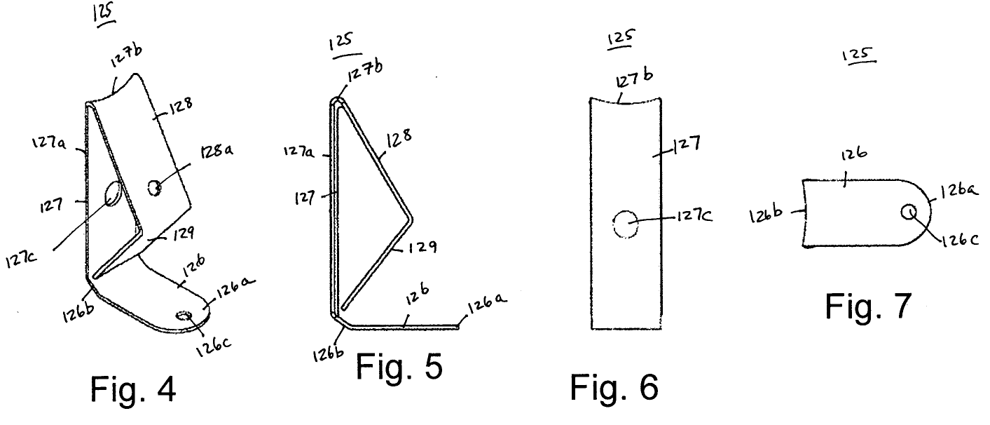

FIG. 4 is an isometric view of the retention spring 125. FIGS. 5-7 are perspective side, front, and bottom views, respectively, of the retention spring 125. With reference to FIGS. 1-7, each retention spring 125 includes a substantially horizontally disposed base member 126 having a first end 126a and a second end 126b. The first end 126a of each base member 126 includes an aperture 126c configured to receive a fastener 140, such as a screw, for coupling the base member 126 to the plaster frame 110.

An elongated engaging member 127 extends from the second end 126b of the base member 126. The engaging member 127 includes an engaging surface 127a disposed opposite the base member 126. The engaging surface 127a has a contour that corresponds to an outer profile of the can 115, proximate the slot 130 corresponding to the retention spring 125. For example, the engaging surface 127a can have a radius of curvature that corresponds to a radius of curvature of a rounded outer profile of the can 115. The corresponding contour and outer profile allow the can 115 and retention spring 125 to have a form-fitting relationship. This form-fitting relationship allows the engaging member 127 to engage the can 115 (and the slot 130) in a substantially air-tight manner when the can 115 is installed within the aperture 110c.

Although illustrated in FIGS. 1-7 as substantially vertical, the engaging member 127 may be angled in certain alternative exemplary embodiments, corresponding to an angled outer profile of the can 115. Similarly, although illustrated in FIGS. 1-7 as curved, the engaging surface 127a may be flat in certain alternative exemplary embodiments, corresponding to a flat outer profile of the can 115.

A receiving member 128 extends from a top edge 127b of the engaging member 127, in a direction towards the first end 126a of the base member 126. An axis of the receiving member 128 forms an acute angle with an axis of the engaging member 127. For example, the axis of the receiving member 128 can form a 45 degree angle with the axis of the engaging member 127.

The engaging member 127 and the receiving member 128 include apertures 127c and 128a, respectively, configured to receive a fastener 131, such as a screw, bolt, nail, or other suitable fastener. The fastener 131 secures the can 115 to the retention spring 125. Once installed within the apertures 127c and 128a, the fastener 131 is disposed at a non-zero angle with respect to an axis of the base member 126. For example, the fastener 131 can be disposed at a about a 45 degree angle with respect to the axis of the bas member. The non-zero angle of the fastener 131 allows an operator to use a standard-sized screwdriver or other tool to loosen and tighten the fastener 131 within the apertures 127c and 128a, because the fastener 131 is directed toward a bottom opening in the can 115. Thus, the operator can easily and efficiently install and adjust the can 115 within the light fixture 100.

A support member 129 extends from a bottom end 128b of the receiving member 128, in a direction towards the second end 126b of the base member 126. An axis of the support member 129 forms an acute angle with the axis of the engaging member 127. For example, the axis of the support member 129 can form a 45 degree angle with the axis of the engaging member 127. The support member 129 is configured to limit bending by the retention spring 125 once the can 115 is fastened to the retention spring 125. In certain alternative exemplary embodiments, the support member 129 may be removed or may otherwise not be used.

A gasket 135 can be disposed between each slot 130 of the can 115 and the retention spring 125 corresponding to the slot 130. The gasket 135 can be configured to provide additional air tightness between the retention springs 125 and the slots 130. In certain alternative exemplary embodiments, the gasket 135 can be omitted. In such embodiments, the form-fitting relationship between the retention springs 125 and the can 115 achieves substantially air tight constraints of the light fixture 100. With or without the gaskets 135, the light fixture 100 can be expected to meet strict air tightness requirements, including Washington's State Energy Code, which requires recessed lighting fixtures to restrict measured air leakage to less than 2 cubic feet per minute at 75 Pascals pressure difference, tested according to a test method set forth in ASTM International Standard E-283.

To install the can 115 within the light fixture 100, an operator can move the can 115 up and down within the aperture 110c of the plaster frame 110 until a bottom edge 115a of the can 115 is flush with a bottom edge of the ceiling. Once the bottom edge of the can 115 is flush with the bottom edge of the ceiling, the operator can align the slots 130 in the can 115 with their corresponding retention springs 125. Specifically, the operator can align the slots 130 with the apertures 127c of the engaging members 127 of the retention springs 125. The operator can attach the can 115 to the retention springs 125 by securing a fastener 131 through the apertures 127c and 128a of each retention spring 125 using a screwdriver or other fastening tool.

To adjust the height of the can 115 after the can 115 is installed within the light fixture 100, the operator can loosen the fasteners 131, move the can 115 up or down within the aperture 110 of the plaster frame 110 until the can 115 reaches a desired position, and reattach the can 115 in the desired position by re-tightening the fasteners 131 within the apertures 127c and 128a. The form-fitting relationship between the can 115 and the retention springs 125 allows the engaging member 127 to engage the can 115 (and the slot 130) in a substantially air-tight manner (for example, complying with Washington's State Energy Code) throughout movement of the can 115 within the aperture 110 and at any selected height of the can 115.

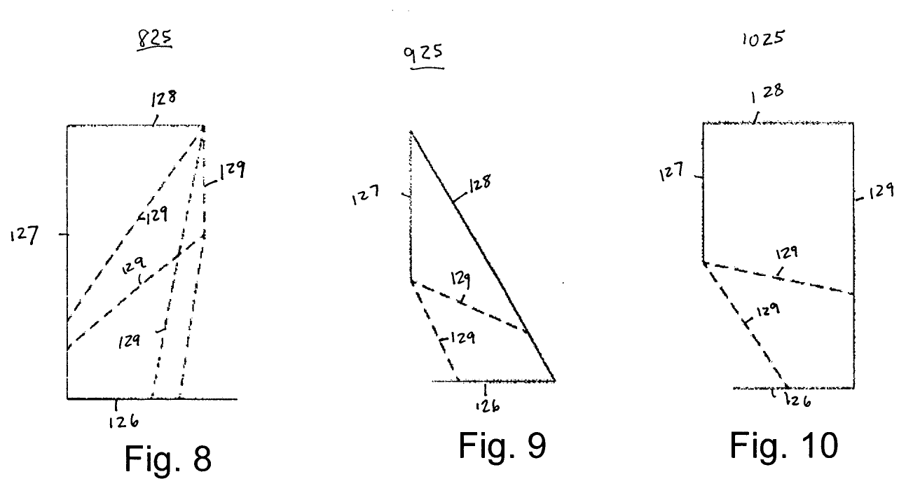

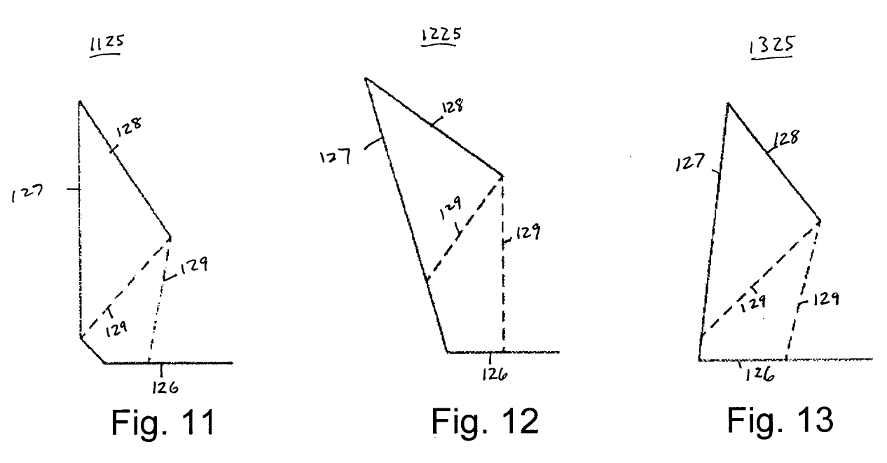

FIGS. 8-13 are perspective side views of retention springs 825-1325, respectively, according to certain alternative exemplary embodiments. Like numerals indicate like elements in the retention springs of FIGS. 8-13 and the retention springs 125 of FIGS. 1-7. Dashed lines in the FIGS. 8-13 indicate optional elements, each of which may be included or omitted, in certain additional alternative exemplary embodiments.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art without departing from the spirit and scope of the present invention defined in the following claims, the scope of which is to be accorded the broadest interpretation so as to encompass such modifications and equivalent structures.

We claim:

1. A retention spring for a recessed lighting fixture, comprising:
a base member having a first end and a second end; and
an elongated engaging member extending from the second end of the base member, the elongated engaging member comprising a surface disposed opposite the base member and having a contour corresponding to an outer profile of a height-adjustable can of the recessed lighting fixture.

2. The retention spring of claim 1, wherein the surface of the engaging member has a radius of curvature that corresponds to a radius of curvature of the can.

3. The retention spring of claim 1, wherein the engaging member comprises a first end and a second end, the first end of the engaging member corresponding to the second end of the base member, the retention spring further comprising a receiving member extending from the second end of the engaging member in a direction towards the first end of the base member.

4. The retention spring of claim 3, wherein an axis of the receiving member forms an acute angle with an axis of the engaging member.

5. The retention spring of claim 3, wherein the engaging member comprises a first aperture and the receiving member comprises a second aperture, the first and second apertures being configured to receive a fastener for securing the can to the retention spring, the first and second apertures being configured to receive the fastener at a non-zero angle with respect to an axis of the base member.

6. The retention spring of claim 3, wherein the receiving member comprises a first end and a second end, the first end of the receiving member corresponding to the second end of the engaging member, the retention spring further comprising a support member extending from the second end of the receiving member in a direction towards the second end of the base member.

7. The retention spring of claim 6, wherein an axis of the support member forms an acute angle with an axis of the engaging member.

8. A recessed lighting fixture, comprising:
a can;
a plaster frame comprising an aperture sized for receiving the can; and
first and second retention springs coupled to the plaster frame, on substantially opposite sides of the aperture, each of the first and second retention springs comprising
a base member having a first end and a second end, and
an elongated engaging member extending from the second end of the base member, the elongated engaging member comprising a surface disposed opposite the base member and having a contour corresponding to an outer profile of the can.

9. The recessed lighting fixture of claim 8, wherein the can comprises an outer profile having a radius of curvature, and wherein the surface of each engaging member has a radius of curvature that corresponds to the radius of curvature of the can.

10. The recessed lighting fixture of claim 8, wherein the engaging member of each retention spring comprises a first end and a second end, the first end of the engaging member corresponding to the second end of the base member, and wherein each retention spring further comprises a receiving member extending from the second end of the engaging member in a direction towards the first end of the base member.

11. The recessed lighting fixture of claim 10, wherein, for each retention spring, an axis of the receiving member forms an acute angle with an axis of the engaging member.

12. The recessed lighting fixture of claim 10, wherein, for each retention spring, the engaging member comprises a first aperture and the receiving member comprises a second aperture, the first and second apertures being configured to receive a fastener for securing the can to the retention spring via the slots.

13. The recessed lighting fixture of claim 12, wherein the first and second apertures are configured to receive the fastener at a non-zero angle with respect to an axis of the base member.

14. The recessed lighting fixture of claim 10, wherein, for each retention spring, the receiving member comprises a first end and a second end, the first end of the receiving member corresponding to the second end of the engaging member, and wherein each retention spring further comprises a support member extending from the second end of the receiving member in a direction towards the second end of the base member.

15. The recessed lighting fixture of claim 14, wherein an axis of the support member forms an acute angle with an axis of the engaging member.

16. The recessed lighting fixture of claim 8, wherein the can is a height-adjustable can configured to accommodate ceiling thicknesses between about ¼″ and 1½.

17. A recessed lighting fixture, comprising:
a plaster frame comprising an aperture;
a can comprising first and second slots and an outer profile, the can being at least partially disposed within the aperture of the plaster frame;
first and second retaining elements coupled to the plaster frame on opposite sides of the aperture, each retaining element being disposed proximate a respective one of the first and second slots of the can, each retaining element comprising
a base member having a first end and a second end, and
an elongated engaging member extending from the second end of the base member, the elongated engaging member comprising a surface having a contour corresponding to the outer profile of the can, proximate to the respective one of the first and second slots.

18. The recessed lighting fixture of claim 17, wherein the outer profile of the can comprises a radius of curvature, and wherein the surface of the engaging member of each retaining element has a radius of curvature that corresponds to the radius of curvature of the outer profile of the can.

19. The recessed lighting fixture of claim 17, wherein the engaging member of each retaining element comprises a first end and a second end, the first end of the engaging member corresponding to the second end of the base member, and wherein each retaining element further comprises a receiving member extending from the second end of the engaging member in a direction towards the first end of the base member.

20. The recessed lighting fixture of claim 19, wherein, for each retaining element, an axis of the receiving member forms an acute angle with an axis of the engaging member.

21. The recessed lighting fixture of claim 19, wherein, for each retaining element, the engaging member comprises a first aperture and the receiving member comprises a second aperture, the first and second apertures being configured to receive a fastener for securing the can to the retaining element.

22. The recessed lighting fixture of claim 22, wherein the first and second apertures are configured to receive the fastener at a non-zero angle with respect to an axis of the base member.

23. The recessed lighting fixture of claim 19, wherein, for each retaining element, the receiving member comprises a first end and a second end, the first end of the receiving member corresponding to the second end of the engaging member, and wherein each retention spring further comprises a support member extending from the second end of the receiving member in a direction towards the second end of the base member.

24. The recessed lighting fixture of claim 23, wherein an axis of the support member forms an acute angle with an axis of the engaging member.

25. A recessed lighting fixture, comprising:
a can having an outer profile;
a plaster frame comprising an aperture sized for receiving the can; and
first and second retention springs coupled to the plaster frame on substantially opposite sides of the aperture, each retention spring comprising
a base member, and
an elongated engaging member extending from the base member via at least one other member, the elongated engaging member comprising a surface having a contour corresponding to the outer profile of the can.
